(19) United States
(12) Patent Application Publication
(10) Pub. No.: US 2021/0376670 A1
(43) Pub. Date: Dec. 2, 2021

(54) STATOR AND MOTOR

(71) Applicant: Nidec Corporation, Kyoto (JP)

(72) Inventor: Shigeharu SUMI, Kyoto (JP)

(21) Appl. No.: 17/276,849

(22) PCT Filed: Jul. 5, 2019
(86) PCT No.: PCT/JP2019/026768

§ 371 Date: Mar. 17, 2021

(30) Foreign Application Priority Data
Sep. 27, 2018 (JP) 2018-181611

(51) Int. Cl. H02K 1/14

(52) U.S. Cl. CPC H02K 1/148

(57) ABSTRACT

A stator includes a core back, teeth, and coils. Each of the coils includes an axially extending portion extending in an axial direction and located on a circumferential first side of a corresponding one of the teeth to which the coil is mounted. Each of the coils includes a coil wire of which a portion defining or functioning as the axially extending portion has a quadrangle shape in sectional view. The core back includes, on its radial first surface, a first core back surface connecting to a joint portion, to which a corresponding one of the teeth is connected, of the radial first surface of the core back.

### CROSS REFERENCE TO RELATED APPLICATIONS

This is a U.S. national stage of PCT Application No. PCT/JP2019/026768, filed on Jul. 5, 2019, and claims priority under U.S.C. § 119(a) and 35 U.S.C. § 365(b) from Japanese Patent Application No. 2018-181611, filed Sep. 27, 2018, the entire disclosures of each of which are hereby incorporated herein by reference.

### 1. FIELD OF THE INVENTION

The present invention relates to a stator and a motor.

### 2. BACKGROUND

In a known stator, a coil is formed of a wire having a quadrangle shape in sectional view. For example, a stator including a coil formed of a wire having a trapezoidal shape in sectional view.

In the stator described above, the coil is apt to have an angular contour. Therefore, the coil is less likely to fit a surface of a core back. As a result, a clearance tends to be defined between the coil and the core back. This may result in unsatisfactory heat radiation from the coil.

### SUMMARY

An example embodiment of the present disclosure provides a stator of a motor including a shaft to rotate about a central axis, the stator including a core back including a ring shape extending around the central axis, a plurality of teeth extending from the core back toward a radial first side and spaced apart from one another in a circumferential direction, and a plurality of coils respectively mounted to the teeth. Each of the coils includes an axially extending portion extending in an axial direction and located on a circumferential first side of a corresponding one of the teeth to which the coil is mounted. Each of the coils is defined by a coil wire of which a portion defining or functioning as the axially extending portion has a quadrangle shape in a sectional view. The core back includes, on a radial first surface, a first core back surface connecting to a joint portion, to which a corresponding one of the teeth is connected, of the radial first surface of the core back. The first core back surface is a flat surface extending in the axial direction and a surface extending from the joint portion toward the circumferential first side and inclined to a radial first side with respect to a direction perpendicular to both the axial direction and a direction in which the teeth extend. The axially extending portion includes, on a radial second surface, a first coil surface opposite a radial first side of the first core back surface. The first coil surface is a flat surface extending along the first core back surface, and is in direct or indirect contact with the first core back surface.

An example embodiment of the present disclosure provides a motor including a stator and a rotor opposite the stator in a radial direction with a clearance between the stator and the rotor.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a sectional view of a motor according to a first example embodiment of the present disclosure.

FIG. 2 is a sectional view of a stator according to the first example embodiment, taken along line II-II in FIG. 1.

FIG. 3 is a partially enlarged sectional view of a portion of the stator according to the first example embodiment illustrated in FIG. 2.

FIG. 4 is a perspective view of a coil according to the first example embodiment.

FIG. 5 is a sectional view of a portion of a stator according to a second example embodiment of the present disclosure.

### DETAILED DESCRIPTION

In the respective drawings, a Z axis illustrated as appropriate extends in a vertical direction, of which a positive side is defined as an “upper side” and a negative side is defined as a “lower side”. Also in the respective drawings, a central axis J illustrated as appropriate indicates an imaginary line that is parallel with the Z axis and extends in the vertical direction. In the following description, the term “axial direction”, “axial”, or “axially” refers to an axial direction of the central axis J, that is, a direction parallel with the vertical direction. The term “radial direction”, “radial”, or “radially” refers to a radial direction from the central axis J. The term “circumferential direction”, “circumferential”, or “circumferentially” refers to a circumferential direction about the central axis J. In the following example embodiments, the term “radial inner side” refers to a radial first side, and the term “radial outer side” refers to a radial second side. Also in the following description, the term “circumferential first side” refers to a clockwise side as seen from above, and the term “circumferential second side” refers to a counterclockwise side as seen from above.

It should be noted that the definitions, “vertical direction”, “upper side”, and “lower side” are merely used for explaining arrangement relationships and the like of constituent elements. Actual arrangement relationships and the like may be arrangement relationships and the like other than the arrangement relationships and the like indicated by the definitions.

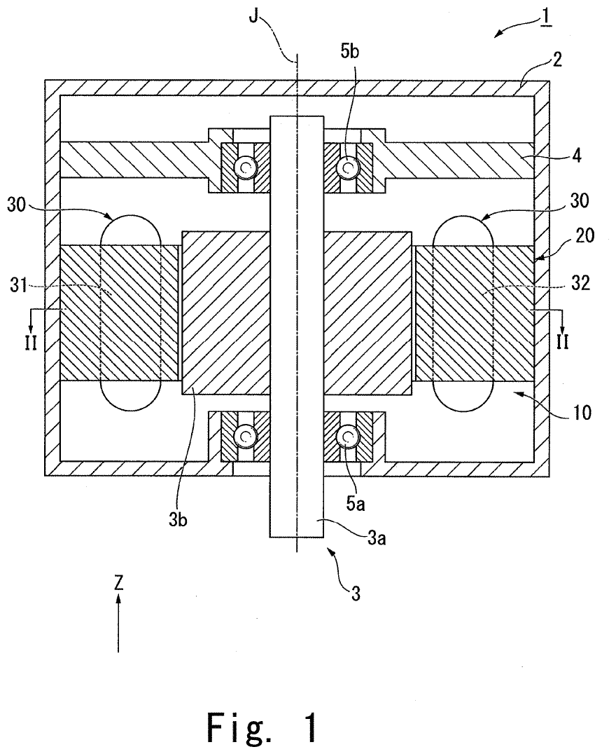

As illustrated in FIG. 1, a motor 1 according to the present example embodiment is of an inner rotor type. The motor 1 includes a housing 2, a rotor 3, a stator 10, a bearing holder 4, and bearings 5a and 5b. The housing 2 accommodates therein the rotor 3, the stator 10, the bearing holder 4, and the bearings 5a and 5b. The rotor 3 is disposed opposite the stator 10 in the radial direction with a clearance defined between the rotor 3 and the stator 10. In the present example embodiment, the rotor 3 is located radially inward of the stator 10. The rotor 3 includes a shaft 3a and a rotor body 3b. In other words, the motor 1 includes the shaft 3a and the rotor body 3b.

The shaft 3a rotates about the central axis J. The shaft 3a has a columnar shape and extends in the axial direction with its center aligned with the central axis J. The shaft 3a is supported by the bearings 5a and 5b so as to be rotatable about the central axis J. The rotor body 3b is fixed to an outer peripheral face of the shaft 3a. Although not illustrated in the drawings, the rotor body 3b includes a rotor core fixed to the shaft 3a and a magnet fixed to the rotor core. The bearing holder 4 holds the bearing 5b.

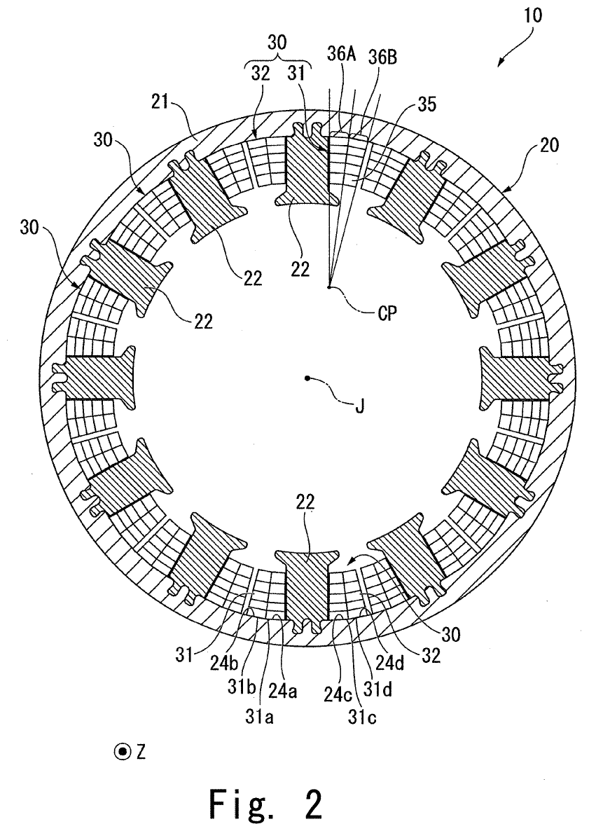

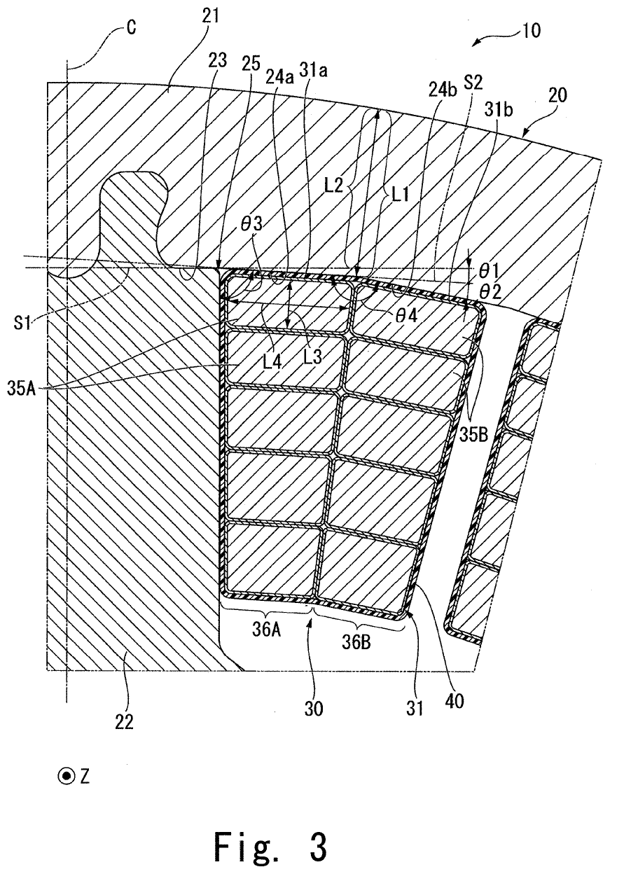

As illustrated in FIGS. 2 and 3, the stator 10 includes a stator core 20, a plurality of coils 30, and insulators 40. FIG. 2 does not illustrate the insulators 40. As illustrated in FIG. 2, the stator core 20 includes a core back 21 having a ring shape and disposed around the central axis J, and a plurality of teeth 22 extending from the core back 21 to the radially inner side. In other words, the stator 10 includes the core back 21 and the plurality of teeth 22.

The teeth 22 are spaced apart from one another in the circumferential direction. The teeth 22 are arranged at equidistant spacings in the circumferential direction. In the present example embodiment, the teeth 22 are separate members from the core back 21. For example, the teeth 22 are fixed to the core back 21 in such a manner that protrusions on radially outer ends of the teeth 22 are respectively press-fitted into recesses in a radially inner face of the core back 21. For example, the number of teeth 22 is 12.

In FIG. 3, a circumferentially central line C indicates an imaginary line passing a circumferential center of each of the teeth 22. In the following description, the term “extending direction” refers to a direction parallel with the circumferentially central line C, that is, a direction in which each tooth 22 extends. In the present example embodiment, the teeth 22 each have circumferentially opposite faces that are parallel with both the axial direction and the extending direction.

In the present example embodiment, the core back 21 has a substantially ring shape with its center aligned with the central axis J. As illustrated in FIG. 3, the core back 21 has, on its radially inner face, a first core back surface 24a and a second core back surface 24b. The first core back surface 24a connects to a joint portion 25, to which a corresponding one of the teeth 22 is connected, of the radially inner face of the core back 21. The joint portion 25 is a portion, to which a radially outer end of a circumferentially first side face of the tooth 22 is connected, of the radially inner face of the core back 21.

The first core back surface 24a is a flat surface extending in the axial direction. The first core back surface 24a is a face extending from the joint portion 25 toward the circumferentially first side while being inclined to the radially inner side with respect to a direction perpendicular to both the axial direction and the extending direction. The direction perpendicular to both the axial direction and the extending direction corresponds to a horizontal direction in FIG. 3.

The first core back surface 24a is gradually apart from an imaginary face S1 that is perpendicular to the extending direction and passes the joint portion 25, toward the radially inner side as the first core back surface 24a is gradually apart from the joint portion 25 toward the circumferentially first side. For example, the imaginary face S1 is flush with a flat surface 23, which is in contact with a radially outer face of the tooth 22, of the radially inner face of the core back 21. An angle θ3 formed by the first core back surface 24a and the circumferentially first side face of the tooth 22 is an acute angle that is less than 90°.

The second core back surface 24b connects to a circumferentially first end of the first core back surface 24a. The second core back surface 24b is a flat surface extending in the axial direction. The second core back surface 24b is a face extending from the circumferentially first end of the first core back surface 24a toward the circumferentially first side while being bent toward the radially inner side with respect to the first core back surface 24a. In other words, the second core back surface 24b is a face extending from the circumferentially first end of the first core back surface 24a toward the circumferentially first side while being inclined to the radially inner side with respect to a direction perpendicular to the axial direction and parallel with the first core back surface 24a. The second core back surface 24b is gradually apart from an imaginary face S2 including the first core back surface 24a, toward the radially inner side as the second core back surface 24b is gradually apart from the first core back surface 24a toward the circumferentially first side.

In the present example embodiment, for example, an inclination θ1 of the first core back surface 24a to the imaginary face S1 is equal to an inclination θ2 of the second core back surface 24b to the first core back surface 24a. The inclination θ2 is also an inclination of the second core back surface 24b to the imaginary face S2. An angle θ4 formed by the first core back surface 24a and the second core back surface 24b is an obtuse angle that is larger than 90° and is less than 180°. Therefore, a radially inner space in the core back 21 can be defined wider than that in a case where the angle θ4 is a right angle or an acute angle, so that the coils 30 can suitably be disposed in the radially inner space with ease.

In the present example embodiment, the first core back surface 24a and the second core back surface 24b extend from an upper end to a lower end of the core back 21. The first core back surface 24a and the second core back surface 24b have the same shape, for example, a rectangular shape as seen from a direction perpendicular to the respective faces. For example, the first core back surface 24a is equal in circumferential dimension to the second core back surface 24b. For example, the first core back surface 24a is equal in area to the second core back surface 24b.

As illustrated in FIG. 2, the core back 21 has, on its radially inner face, a first core back surface 24c and a second core back surface 24d. The first core back surface 24a and the first core back surface 24c are symmetrically arranged with a corresponding one of the teeth 22 interposed therebetween in the circumferential direction. The second core back surface 24b and the second core back surface 24d are symmetrically arranged with a corresponding one of the teeth 22 interposed therebetween in the circumferential direction. The first core back surface 24a, 24c and the second core back surface 24b, 24d are provided for each tooth 22. Specifically, the first core back surface and the second core back surface are symmetrically provided in a pair for each tooth 22 with a corresponding one of the teeth 22 interposed therebetween in the circumferential direction. As a result, the first core back surfaces 24a, 24c and the second core back surfaces 24b, 24d are spaced apart from one another in the circumferential direction. Since the first core back surfaces 24a, 24c and the second core back surfaces 24b, 24d are provided, the teeth 22 have substantially polygonal-shaped radially inner faces as seen from the axial direction.

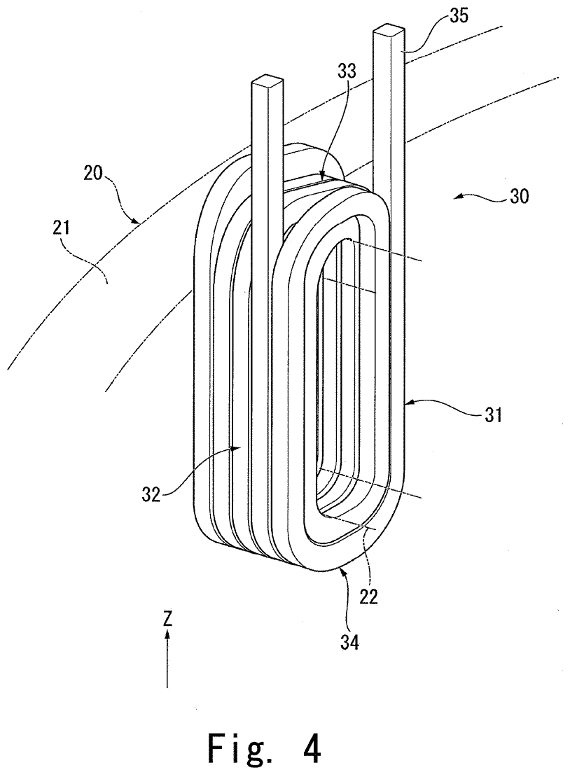

Each of the coils 30 is mounted to a corresponding one of the teeth 22. As illustrated in FIG. 4, each of the coils 30 is formed by winding a coil wire 35 around a corresponding one of the teeth 22. In the present example embodiment, the coil wire 35 is an enameled wire having an enamel-coated surface. The coil wire 35 has a quadrangle shape in sectional view. More specifically, the coil wire 35 has a trapezoidal shape in sectional view. As illustrated in FIG. 2, in the present example embodiment, the coil 30 has a multilayer structure of the coil wire 35 wound multiple times. For example, the coil 30 has a structure of the coil wire 35 wound twice. In other words, the coil 30 has a first layer 36A and a second layer 36B.

The first layer 36A is a layer located innermost among the layers of the coil 30. The second layer 36B is a layer adjacent to an outer side of the first layer 36A among the layers of the coil 30. In the present example embodiment, since the coil 30 has the structure of the coil wire 35 wound twice, the second layer 36B is a layer located outermost among the layers of the coil 30.

The coil 30 may be formed by winding the coil wire 35 around the tooth 22 in sequence or may be formed by winding the coil wire 35 around a roll core different from the tooth 22 in sequence. In the case of forming the coil 30 by winding the coil wire 35 around the roll core, the coil 30 is detached from the roll core, and then is mounted to the tooth 22.

As illustrated in FIG. 4, the coil 30 includes a pair of axially extending portions 31 and 32 and a pair of circumferentially extending portions 33 and 34. The axially extending portion 31 is located on the circumferentially first side of the tooth 22 to which the coil 30 is mounted. The axially extending portion 32 is located on the circumferentially second side of the tooth 22 to which the coil 30 is mounted. The axially extending portions 31 and 32 extend in the axial direction. The axially extending portions 31 and 32 are located with the tooth 22 interposed therebetween in the circumferential direction.

The circumferentially extending portion 33 is located on the upper side of the tooth 22 to which the coil 30 is mounted. The circumferentially extending portion 34 is located on the lower side of the tooth 22 to which the coil 30 is mounted. The circumferentially extending portions 33 and 34 extend in the circumferential direction. The circumferentially extending portion 33 connects to an upper end of the axially extending portion 31 and an upper end of the axially extending portion 32. The circumferentially extending portion 34 connects to a lower end of the axially extending portion 31 and a lower end of the axially extending portion 32.

As illustrated in FIG. 3, the axially extending portion 31 has a plurality of coil wire portions 35A and a plurality of coil wire portions 35B that are tied together into bundles. The coil wire portions 35A, 35B constitute the axially extending portion 31 of the coil wire 35 constituting the coil 30. The coil wire portions 35A, 35B extend in the axial direction. The coil wire portions 35A are juxtaposed in the radial direction to form the first layer 36A in the axially extending portion 31. The coil wire portions 35B are juxtaposed in the radial direction to form the second layer 36B in the axially extending portion 31.

The coil wire portions 35A, 35B each have a quadrangle shape in sectional view. The term “quadrangle shape” as used herein involves a strictly quadrangle shape and a substantially quadrangle shape. The term “substantially quadrangle shape” as used herein involves a chamfered quadrangle shape. In the present example embodiment, the coil wire portions 35A, 35B each have a substantially quadrangle shape in sectional view, of which the corners are rounded.

As described above, the coil wire portions 35A, 35B each have a quadrangle shape in sectional view. Therefore, a clearance between the coil wire portions 35A, 35B becomes smaller than a clearance in a case where the coil wire portions 35A, 35B each have a circular shape in sectional view. As a result, the coil wire portions 35A, 35B can be arranged densely. This configuration thus enables improvement in space factor of the coils 30. This configuration therefore enables improvement in energy efficiency of the motor 1.

In the present example embodiment, the coil wire portions 35A, 35B each have a trapezoidal shape in sectional view, of which the circumferential dimension gradually decreases toward the radially inner side. The term “trapezoidal shape” as used herein involves a strictly trapezoidal shape and a substantially trapezoidal shape. The term “substantially trapezoidal shape” as used herein involves a chamfered trapezoidal shape. In the present example embodiment, the coil wire portions 35A, 35B each have a substantially trapezoidal shape in sectional view, of which the corners are rounded.

Each of the coil wire portions 35A has a radial dimension L3. Of the coil wire portions 35A, a coil wire portion 35A closer to the radially inner side has a larger radial dimension L3. Each of the coil wire portions 35A has a circumferential dimension L4. Of the coil wire portions 35A, a coil wire portion 35A closer to the radially inner side has a smaller circumferential dimension L4. The coil wire portions 35A radially arranged are equal in sectional area to one another. Likewise, each of the coil wire portions 35B has a radial dimension. Of the coil wire portions 35B, a coil wire portion 35B closer to the radially inner side has a larger radial dimension. Each of the coil wire portions 35B has a circumferential dimension. Of the coil wire portions 35B, a coil wire portion 35b closer to the radially inner side has a smaller circumferential dimension. The coil wire portions 35B radially arranged are equal in sectional area to one another. The coil wire portions 35A are equal in sectional area to the coil wire portions 35B. The coil wire portions 35A and coil wire portions 35B that are respectively adjacent to each other in the circumferential direction are equal in sectional shape to each other.

Radially adjacent two of the coil wire portions 35A have radial side faces that are in contact with each other. The coil wire portions 35A adjoin to the circumferentially first side of the tooth 22. The coil wire portions 35A have circumferentially second side faces that are in direct or indirect contact with a circumferentially first side face of the tooth 22. In the present example embodiment, the circumferentially second side faces of the coil wire portions 35A are in indirect contact with the circumferentially first side face of the tooth 22 with the insulator 40 interposed between the coil wire portions 35A and the tooth 22.

Radially adjacent two of the coil wire portions 35B have radial side faces that are in contact with each other. The coil wire portions 35B respectively adjoin to circumferentially first sides the coil wire portions 35A. The coil wire portions 35A, 35B are thus juxtaposed in the circumferential direction and the radial direction. Of the coil wire portions 35A, 35B, coil wire portions 35A, 35B that are adjacent to each other in the circumferential direction have circumferential side faces that are in contact with each other.

The axially extending portion 31 has a fan-shaped contour in a section perpendicular to the axial direction. The term “fan shape” as used herein involves a shape surrounded by two arcs that are equal in center of curvature to each other and are different in radius from each other, and two line segments extending in radius directions of circles with their centers aligned with the centers of curvature and respectively connecting to opposite ends of the two arcs. The term “fan shape” as used herein involves a strictly fan shape and a substantially fan shape. The term “substantially fan shape” as used herein involves a shape in which fan-shaped arcs are approximated by a plurality of line segments. In the present example embodiment, the contour of the axially extending portion 31 in the section perpendicular to the axial direction has the shape surrounded with the two arcs and two line segments as described above, and the two arcs are approximated by the two line segments. The contour of the axially extending portion 31 in the section perpendicular to the axial direction has a circumferential dimension that gradually decreases toward the radially inner side. As illustrated in FIG. 2, the contour of the axially extending portion 31 in the section perpendicular to the axial direction has a center of curvature CP that is located on the radially inner side of the core back 21 and is different in position from the central axis J.

Each of the axially extending portions 31 has the fan-shaped contour as described above. Therefore, the coils 30 can suitably be arranged between the circumferentially adjacent teeth 22 in a dense state. In the present example embodiment, the coil wire portions 35A, 35B each have the trapezoidal shape in sectional view, of which the circumferential dimension gradually decreases toward the radially inner side. Therefore, the contour of each axially extending portion 31 can easily be formed into the fan shape of which the circumferential dimension gradually decreases toward the radially inner side.

As illustrated in FIG. 3, the axially extending portion 31 has, on its radially outer face, a first coil surface 31a and a second coil surface 31b. In the present example embodiment, the radially outer face of the axially extending portion 31 is composed of two faces, that is, the first coil surface 31a and the second coil surface 31b. The first coil surface 31a is disposed opposite the radially inner side of the first core back surface 24a. The first coil surface 31a is a flat surface extending along the first core back surface 24a. The first coil surface 31a and the first core back surface 24a are parallel with each other.

The first coil surface 31a is in direct or indirect contact with the first core back surface 24a. Heat from the coil 30 can thus be transferred to the core back 21 via the first coil surface 31a and the first core back surface 24a. This configuration therefore enables improvement in heat radiation from the coil 30.

According to the present example embodiment, as described above, the core back 21 has, on its radially inner face, a flat surface in accordance with at least a part of the radially outer face of each coil 30. This configuration therefore decreases a clearance between the coil 30 and the core back 21, and allows the radially outer face of the coil 30 to suitably come into contact with the radially inner face of the core back 21. This configuration therefore allows even a coil 30 formed of a coil wire 35 at least partially having a quadrangle shape in sectional view to suitably come into contact with the core back 21, and enables improvement in heat radiation from the coil 30. In addition, this configuration achieves surface contact between the coil 30 and the core back 21, and therefore suitably enables improvement in heat radiation from the coil 30.

According to the present example embodiment, the circumferentially second side faces of the coil wire portions 35A are in direct or indirect contact with the circumferentially first side face of the tooth 22. Therefore, heat is easily transferred from the coil wire portions 35A to the tooth 22. This configuration therefore enables further improvement in heat radiation from the coils 30. In addition, this configuration achieves surface contact between the coils 30 and the teeth 22, and therefore enables improvement in heat radiation from the coils 30 more suitably.

According to the present example embodiment, the first core back surface 24a is the face extending from the joint portion 25 toward the circumferentially first side while being inclined to the radially inner side with respect to the direction perpendicular to both the axial direction and the extending direction. As illustrated in FIG. 3, therefore, the radial dimension L1 of the portion, which serves as the first core back surface 24a, of the core back 21 can be increased as compared with that in a case where the first core back surface 24a extends in parallel with the direction perpendicular to both the axial direction and the extending direction. This configuration therefore allows a magnetic flux to suitably pass the core back 21, and inhibits degradation in magnetic characteristics of the motor 1. In other words, the present example embodiment ensures heat radiation from the coils 30, and also ensures magnetic characteristics of the motor 1.

In FIG. 3, “L2” indicates the radial dimension of the portion, which serves as the first core back surface 24a, of the core back 21 in the case where the first core back surface 24a extends in parallel with the direction perpendicular to both the axial direction and the extending direction.

According to the present example embodiment, the motor 1 is of an inner rotor type in which the teeth 22 extend from the core back 21 toward the radially inner side. Therefore, heat transferred to the core back 21 is easily released to the outside via the housing 2. This configuration therefore enables improvement in heat radiation from the motor 1.

In the present example embodiment, the first coil surface 31a is in indirect contact with the first core back surface 24a with the insulator 40 interposed between the first coil surface 31a and the first core back surface 24a. Therefore, heat is transferred from the first coil surface 31a to the first core back surface 24a via the insulator 40. In the present example embodiment, the first coil surface 31a is a radially outer face of the first layer 36A. More specifically, the first coil surface 31a is a radially outer face of the coil wire portion 35A located radially outermost among the coil wire portions 35A of the axially extending portion 31.

The second coil surface 31b is disposed opposite the radially inner side of the second core back surface 24b. The second coil surface 31b connects to the first coil surface 31a. More specifically, the second coil surface 31b connects to a circumferentially first end of the first coil surface 31a. The second coil surface 31b is a flat surface extending along the second core back surface 24b. The second coil surface 31b and the second core back surface 24b are parallel with each other. The second coil surface 31b extends in a direction in which the second coil surface 31b is bent toward the radially inner side with respect to the first coil surface 31a as seen from the axial direction.

The second coil surface 31b is in direct or indirect contact with the second core back surface 24b. Heat from the coil 30 can thus be transferred to the core back 21 via the second coil surface 31b and the second core back surface 24b. This configuration therefore enables further improvement in heat radiation from the coil 30. In the present example embodiment, as described above, the radially outer face of the axially extending portion 31 is composed of the two faces, that is, the first coil surface 31a and the second coil surface 31b. Therefore, this configuration enables improvement in heat radiation from the coil 30 more suitably in such a manner that the radially inner face of the core back 21 is provided with a face that is in contact with the entire radially outer face of the axially extending portion 31.

In the present example embodiment, the second coil surface 31b is in indirect contact with the second core back surface 24b with the insulator 40 interposed between the second coil surface 31b and the second core back surface 24b. Therefore, heat is transferred from the second coil surface 31b to the second core back surface 24b via the insulator 40. In the present example embodiment, the second coil surface 31b is a radially outer face of the second layer 36B. More specifically, the second coil surface 31b is a radially outer face of the coil wire portion 35B located radially outermost among the coil wire portions 35B of the axially extending portion 31.

According to the present example embodiment, as described above, each coil surface is formed of the radially outer face of the first layer 36A and the radially outer face of the second layer 36B. This configuration therefore allows the respective layers to come into contact with the first core back surface 24a and the second core back surface 24b in accordance with the shapes of the respective layers. Heat from the respective layers of the coil 30 can thus suitably be transferred to the core back 21.

As illustrated in FIG. 2, the axially extending portion 31 and the axially extending portion 32 are symmetrically arranged with a corresponding one of the teeth 22 interposed therebetween in the circumferential direction. The axially extending portion has, as in the axially extending portion 31, a first coil surface 31c and a second coil surface 31d. The first coil surface 31a and the first coil surface 31c are symmetrically arranged with a corresponding one of the teeth 22 interposed therebetween in the circumferential direction. The second coil surface 31b and the second coil surface 31d are symmetrically arranged with a corresponding one of the teeth 22 interposed therebetween in the circumferential direction. The first coil surface 31c is in direct or indirect contact with the first core back surface 24c. The second coil surface 31d is in direct or indirect contact with the second core back surface 24d.

According to the present example embodiment, as described above, the first core back surface and the second core back surface are symmetrically arranged in a pair for each tooth 22 with a corresponding one of the teeth 22 interposed therebetween in the circumferential direction, and each coil 30 includes the pair of axially extending portions symmetrically arranged with a corresponding one of the teeth 22 interposed therebetween in the circumferential direction. Therefore, heat can be transferred from the pair of first coil surfaces 31a and 31c as well as the pair of second coil surfaces 31b and 31d to the pair of first core back surfaces 24a and 24c as well as the pair of second core back surfaces 24b and 24d for each coil 30. This configuration therefore enables further improvement in heat radiation from the coils 30.

As illustrated in FIG. 3, each of the insulators 40 is a sheet-shaped insulating member. Each of the insulators 40 may be an insulating tape or an insulating sheet of paper. In the present example embodiment, the insulators 40 are respectively provided for the axially extending portions 31 and 32. The insulators 40 are respectively wound around the axially extending portions 31 and 32. As illustrated in FIG. 3, the insulator 40 on the axially extending portion 31 surrounds the axially extending portion 31 in the section perpendicular to the axial direction. Although not illustrated in the drawings, the insulator 40 on the axially extending portion 32 surrounds the axially extending portion 32 in the section perpendicular to the axial direction. The insulators 40 are respectively provided to cover almost the entire axially extending portions 31 and 32 in the axial direction.

The insulators 40 further insulate the coils 30 from the stator core 20. The insulators 40 each having a sheet shape are less likely to hamper heat transfer from the first coil surface 31a and second coil surface 31b to the first core back surface 24a and second core back surface 24b. This configuration therefore ensures a suitable insulating property and inhibits lowering of heat radiation from the coils 30. Likewise, the insulators 40 are also less likely to hamper heat transfer from the circumferential side faces of the coils 30 to the circumferential side faces of the teeth 22. This configuration therefore further inhibits lowering of heat radiation from the coils 30.

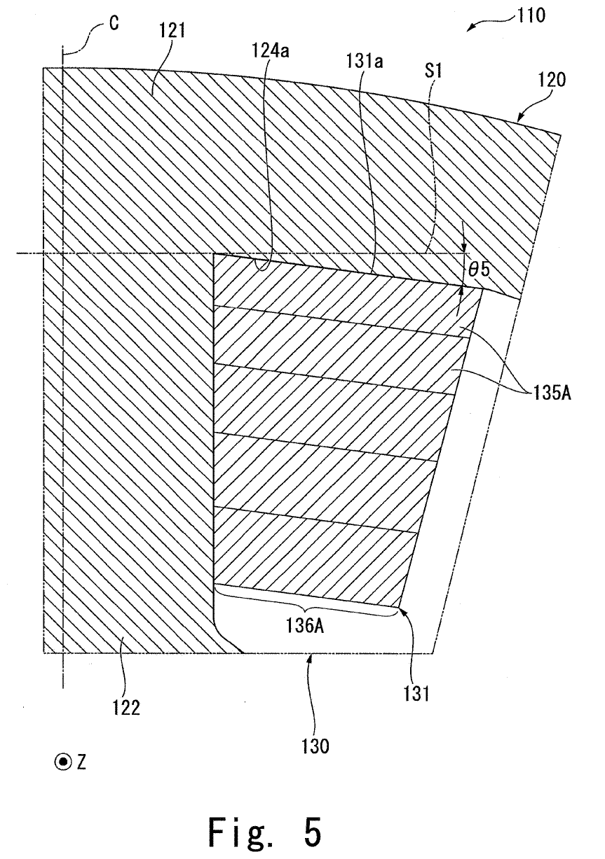

Another example embodiment is illustrated by FIG. 5. As illustrated in FIG. 5, in a stator 110 according to the present example embodiment, teeth 122 of a stator core 120 are integrated with a core back 121. The core back 121 has on its radially inner face a first core back surface 124a. For example, an inclination θ5 of the first core back surface 124a to an imaginary face S1 is larger than the inclination θ1 of the first core back surface 24a in the one example embodiment. The core back 121 has no second core back surface 24b on its radially inner face, unlike the one example embodiment.

In the present example embodiment, coils 130 each have a single-layer structure of a coil wire wound once. In other words, each coil 30 has only a first layer 136A. An axially extending portion 131 has a plurality of coil wire portions 135A that are tied together into bundles in the radial direction to form the first layer 136A. A contour of the axially extending portion 131 in a section perpendicular to the axial direction has a trapezoidal shape of which a circumferential dimension gradually decreases toward the radially inner side. The axially extending portion 131 has a radially outer face composed of the first coil surface 131a. The first coil surface 131a is a radially outer face of the first layer 136A. The first coil surface 131a is in direct contact with the first core back surface 124a. Also in the present example embodiment, as in the one example embodiment, heat from the coil 130 can suitably be transferred to the core back 121 via the first coil surface 131a and the first core back surface 124a. This configuration therefore enables improvement in heat radiation from the coil 130.

In the present example embodiment, the stator 110 includes no insulator 40 unlike the one example embodiment. Therefore, the first coil surface 131a is in direct contact with the first core back surface 124a. This configuration therefore enables further improvement in heat radiation from the coil 130. It should be noted that an insulating coating may be applied to a surface of at least one of the stator core 120 and the coil 130, in place of the insulator 40. FIG. 5 does not illustrate an enamel coating on the coil wire portion 135A.

The present disclosure is not limited to the foregoing example embodiments, but can adopt other configurations. The axially extending portion may have, on its radially outer face, one or more coil surfaces connecting to the circumferentially first side of the second coil surface. In this case, the coil surfaces connecting to the circumferentially first side of the second coil surface extend to be bent toward the radially inner side with respect to coil surfaces connecting to the circumferentially second side. In this case, each coil may have a multilayer structure of three or more layers. The one or more coil surfaces connecting to the circumferentially first side of the second coil surface may be configured with the third layer and layers located outside the third layer. Also in this case, the core back may further have, on its radially inner face, a core back surface that is in contact with each coil surface.

The sectional shape of the coil wire may be different from a quadrangle shape at a portion excluding the axially extending portion as long as the axially extending portion has a quadrangle shape. For example, the coil wire may have a circular shape in sectional view at the circumferentially extending portions located on both sides of each tooth in the axial direction. The sectional shape of the portion, which serves as the axially extending portion, of the coil wire in each coil is not necessarily trapezoidal shape as long as it is a quadrangle shape.

In the one example embodiment, the inclination θ1 of the first core back surface 24a may be different from the inclination θ2 of the second core back surface 24b. The angle θ4 formed by the first core back surface 24a and the second core back surface 24b may be a right angle or an acute angle. The first core back surface 24a may be different in circumferential dimension from the second core back surface 24b. The first core back surface 24a may be different in area from the second core back surface 24b.

In the foregoing example embodiments, the radially first side is a radially inner side, and the radially second side is a radially outer side; however, the present disclosure is not limited thereto. The radially first side may be a radially outer side, and the radially second side may be a radially inner side. In other words, the motor may be of an outer-rotor type.

The motor according to each of the foregoing example embodiments may be used for any purpose. The motor according to each of the foregoing example embodiments is mounted on, for example, a vehicle, an unmanned moving unit, a power-assisted apparatus, a robot system, and the like. It should be noted that the respective configurations described herein may be appropriately combined insofar as there are no inconsistencies.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-9. (canceled)

10. A stator of a motor including a shaft to rotate about a central axis, the stator comprising:
a core back including a ring shape extending around the central axis;
a plurality of teeth extending from the core back toward a radial first side and spaced apart from one another in a circumferential direction; and
a plurality of coils respectively mounted to the teeth;
wherein
each of the coils includes an axially extending portion extending in an axial direction and located on a circumferential first side of a corresponding one of the teeth to which the coil is mounted;
each of the coils includes a coil wire of which a portion defining or functioning as the axially extending portion has a quadrangle shape in sectional view;
the core back includes, on a radial first surface, a first core back surface connecting to a joint portion, to which a corresponding one of the teeth is connected, of the radial first surface of the core back;
the first core back surface is a flat surface extending in the axial direction and a surface extending from the joint portion toward the circumferential first side while being inclined to a radial first side with respect to a direction perpendicular to both the axial direction and a direction in which the teeth extend;
the axially extending portion includes, on a radial second surface, a first coil surface opposite to a radial first side of the first core back surface; and
the first coil surface is a flat surface extending along the first core back surface, and is in direct or indirect contact with the first core back surface.

11. The stator according to claim 10, wherein
the core back includes, on the radial first surface, a second core back surface connecting to a circumferential first end of the first core back surface;
the second core back surface is a flat surface extending in the axial direction and a surface extending from the circumferential first end of the first core back surface toward the circumferential first side while bending toward the radial first side with respect to the first core back surface;
the axially extending portion includes, on the radial second surface, a second coil surface connecting to the first coil surface and opposite to a radial first side of the second core back surface; and
the second coil surface is a flat surface extending along the second core back surface, and is in direct or indirect contact with the second core back surface.

12. The stator according to claim 11, wherein
the first core back surface and the second core back surface define an obtuse angle.

13. The stator according to claim 11, wherein
each of the coils includes a multilayer structure of the coil wire wound multiple times;
the first coil surface is a radial second surface of a first layer located innermost among the layers of each coil; and
the second coil surface is a radial second surface of a second layer adjacent to an outer side of the first layer among the layers of each coil.

14. The stator according to claim 11, wherein
the first core back surface and the second core back surface are provided symmetrically in a pair for each tooth of the plurality of teeth with a corresponding one of the plurality of teeth interposed therebetween in the circumferential direction; and
each of the coils includes a pair of the axially extending portions symmetrically provided with a corresponding one of the teeth interposed therebetween in the circumferential direction.

15. The stator according to claim 10, wherein
the portion, which defines or functions as the axially extending portion, of each coil wire has a trapezoidal shape in a sectional view, of which a circumferential dimension decreases toward the radial first side.

16. The stator according to claim 10, further comprising:
an insulator including a sheet shape and wound around the axially extending portion; wherein
the first coil surface is in indirect contact with the first core back surface with the insulator interposed between the first coil surface and the first core back surface.

17. The stator according to claim 10, wherein
the radial first side is a radial inner side, and
the radial second side is a radial outer side.

18. A motor comprising:
the stator according to claim 10; and
a rotor opposite the stator in a radial direction with a clearance defined between the rotor and the stator.
